(19) United States
(12) Patent Application Publication
(10) Pub. No.: US 2019/0143312 A1
(43) Pub. Date: May 16, 2019

(54) HONEYCOMB STRUCTURE AND PRODUCTION METHOD FOR SAID HONEYCOMB STRUCTURE

(71) Applicants: IBIDEN CO., LTD., Ogaki-shi (JP); TOYOTA JIDOSHA KABUSHIKI KAISHA, Toyota-shi (JP)

(72) Inventors: Shinnosuke GOTO, Ibi-gun (JP); Takumi TOJO, Toyota-shi (JP); Takeru YOSHIDA, Toyota-shi (JP); Hiromasa SUZUKI, Toyota-shi (JP)

(73) Assignees: IBIDEN CO., LTD., Ogaki-shi (JP); TOYOTA JIDOSHA KABUSHIKI KAISHA, Toyota-shi (JP)

(21) Appl. No.: 16/245,255

(22) Filed: Jan. 11, 2019

Related U.S. Application Data
(63) Continuation of application No. PCT/JP2017/025475, filed on Jul. 13, 2017.

(30) Foreign Application Priority Data
Jul. 14, 2016 (JP) 2016-139683

(51) Int. Cl. B01J 35/04; B01J 23/10; B01J 37/08

(52) U.S. Cl. CPC B01J 35/04; B01J 37/12; B01J 37/08; B01J 23/10

(57) ABSTRACT

The present invention relates to a honeycomb structured body including a honeycomb fired body in which multiple through-holes are arranged longitudinally in parallel with one another with a partition wall therebetween, wherein the honeycomb fired body is an extrudate containing ceria-zirconia composite oxide particles and alumina particles, the ceria-zirconia composite oxide particles have an average particle size of 1 to 50 μm, and the ceria-zirconia composite oxide particles include a cracked particle.

### TECHNICAL FIELD

The present invention relates to a honeycomb structured body and a method for producing the honeycomb structured body.

### BACKGROUND ART

Exhaust gas discharged from internal combustion engines of automobiles and the like contains harmful gases such as carbon monoxide (CO), nitrogen oxides (NOx), and hydrocarbons (HC). An exhaust gas catalytic converter that decomposes such harmful gases is also referred to as a three-way catalytic converter. A common three-way catalytic converter includes a catalyst layer that is formed by wash-coating a honeycomb-shaped monolithic substrate made of cordierite or the like with slurry containing noble metal particles having catalytic activity.

Meanwhile, Patent Literature 1 discloses an exhaust gas catalytic converter including a monolithic substrate containing ceria-zirconia composite oxide particles and θ-phase alumina particles, wherein noble metal particles are supported on the monolithic substrate.

### CITATION LIST

### Patent literature

Patent Literature 1: JP 2015-85241 A

### SUMMARY OF INVENTION

### Technical Problem

In the exhaust gas catalytic converter disclosed in Patent Literature 1, the monolithic substrate does not contain cordierite as its material but contains a material that serves as a catalyst carrier and as a co-catalyst. Thus, the bulk density is low, and the monolithic substrate is easily heated, which is considered to contribute to improving warm-up performance of the catalytic converter.

The term “warm-up performance” of a catalytic converter as used herein refers to the period of time required for the catalytic converter to exhibit sufficient exhaust gas conversion performance after the engine has started. The warm-up performance is considered to be excellent when the catalytic converter can exhibit sufficient exhaust gas conversion performance within a short period of time after the engine has started.

In the exhaust gas catalytic converter disclosed in Patent Literature 1, the ceria-zirconia composite oxide particles and the θ-phase alumina particles constituting the monolithic substrate both have high coefficients of thermal expansion, so that the monolithic substrate might break depending on use conditions, such as a condition which increases the volume of the exhaust gas catalytic converter.

The present invention was made to solve the above problem, and aims to provide a honeycomb structured body having high thermal shock resistance and a method for producing the honeycomb structured body.

### Solution to Problem

The honeycomb structured body of the present invention for achieving the above object is a honeycomb structured body including a honeycomb fired body in which multiple through-holes are arranged longitudinally in parallel with one another with a partition wall therebetween, wherein the honeycomb fired body is an extrudate containing ceria-zirconia composite oxide particles and alumina particles, the ceria-zirconia composite oxide particles have an average particle size of 1 to 50 μm, and the ceria-zirconia composite oxide particles include a cracked particle.

In the honeycomb structured body of the present invention, the honeycomb fired body is an extrudate containing ceria-zirconia composite oxide particles and alumina particles. The ceria-zirconia composite oxide particles constituting the honeycomb fired body contain a cracked particle.

The cracked particle is a ceria-zirconia composite oxide particle having a crack formed therein.

The ceria-zirconia composite oxide particles have a high coefficient of thermal expansion. Yet, when cracks are formed in the particles, even if the ceria-zirconia composite oxide particles thermally expand or contract, the cracks in the particles can absorb such expansion and contraction. As a result, thermal shock damage to the entire honeycomb structured body can be prevented, resulting in a honeycomb structured body having high thermal shock resistance.

Whether or not the ceria-zirconia composite oxide particles include cracked particles can be confirmed by observation of an electron microscope image of the honeycomb fired body. In the electron microscope image of the honeycomb fired body, if a crack is found in three or more out of ten ceria-zirconia composite oxide particles, it is determined that the ceria-zirconia composite oxide particles include cracked particles.

The average particle size of the ceria-zirconia composite oxide particles can also be confirmed by observation of an electron microscope image of the honeycomb fired body.

Cracks can be easily formed in the ceria-zirconia composite oxide particles having an average particle size of 1 to 50 μm.

In the honeycomb structured body of the present invention, the alumina particles are preferably θ-phase alumina particles.

With the use of the θ-phase alumina particles as separators of the ceria-zirconia composite oxide particles, it is possible to increase the size of the pores in the partition walls, thus allowing gas to easily diffuse into the partition walls. In addition, with the use of the θ-phase alumina particles, it is possible to prevent phase change of the alumina in exhaust gas, thus further improving heat resistance.

The honeycomb structured body of the present invention preferably has a length to diameter ratio (length/diameter) of 0.5 to 0.9.

The honeycomb structured body having a length/diameter ratio of 1 or less can have a narrower temperature distribution therein. Thus, the honeycomb structured body can achieve higher thermal shock resistance.

The honeycomb structured body of the present invention preferably has a diameter of 130 mm or less.

The honeycomb structured body having a diameter of 130 mm or less can have a narrower temperature distribution therein. Thus, the honeycomb structured body can achieve higher thermal shock resistance.

In the honeycomb structured body of the present invention, a noble metal is preferably supported on the honeycomb fired body.

The honeycomb fired body in the form of an extrudate containing the ceria-zirconia composite oxide particles and the alumina particles serves as a catalyst carrier and as a co-catalyst by itself. Thus, a noble metal can be directly supported on the honeycomb fired body. Further, with a noble metal directly supported on the honeycomb fired body, the honeycomb structured body can be easily heated, which can improve the initial exhaust gas conversion performance.

The method for producing a honeycomb structured body of the present invention is a method for producing a honeycomb structured body including a honeycomb fired body in which multiple through-holes are arranged longitudinally in parallel with one another with a partition wall therebetween, the method including a heat-treating step of heat-treating ceria-zirconia composite oxide particles at 700° C. to 1000° C. for 1 to 24 hours while repeatedly switching between a reducing atmosphere and an oxidizing atmosphere to form cracks in at least some of the ceria-zirconia composite oxide particles; a molding step of molding a raw material paste containing the ceria-zirconia composite oxide particles including a cracked particle and alumina particles into a honeycomb molded body in which multiple through-holes are arranged longitudinally in parallel with one another with a partition wall therebetween; and a firing step of firing the honeycomb molded body into a honeycomb fired body.

According to the method for producing a honeycomb structured body, before molding to produce a honeycomb molded body, the ceria-zirconia composite oxide particles are heat-treated at 700° C. to 1000° C. for 1 to 24 hours while repeatedly switching between a reducing atmosphere and an oxidizing atmosphere to form cracks in at least some of the ceria-zirconia composite oxide particles.

When the ceria-zirconia composite oxide particles including cracked particles are used to produce a honeycomb fired body, the cracked particles used as a raw material remain in the resulting honeycomb fired body, with the cracks in the particles. Thus, it is possible to produce a honeycomb structured body having high thermal shock resistance.

The reducing atmosphere is an atmosphere in which oxygen can be released from the ceria-zirconia composite oxide particles. For example, it is an atmosphere with 0.5 vol % of carbon monoxide, 0 vol % of oxygen, and 99.5 vol % of nitrogen. The oxidizing atmosphere is an atmosphere in which oxygen can be absorbed into the ceria-zirconia composite oxide particles. For example, it is an atmosphere with 5 vol % of oxygen and 95 vol % of nitrogen.

The method for producing a honeycomb structured body of the present invention preferably further includes a supporting step of allowing a noble metal to be supported on the honeycomb fired body.

The honeycomb structured body can be used as a honeycomb catalytic converter for exhaust gas conversion with a noble metal supported on the honeycomb fired body.

### BRIEF DESCRIPTION OF DRAWINGS

FIG. 1 is a perspective view schematically showing an exemplary honeycomb structured body of the present invention.

FIG. 2 is an electron microscope image of a honeycomb fired body containing a cracked particle.

### DESCRIPTION OF EMBODIMENTS

### (Honeycomb Structured Body)

First, the honeycomb structured body of the present invention is described.

The honeycomb structured body of the present invention includes a honeycomb fired body in which multiple through-holes are arranged longitudinally in parallel with one another with a partition wall therebetween.

In the honeycomb structured body of the present invention, the honeycomb fired body is an extrudate containing ceria-zirconia composite oxide particles (hereinafter also referred to as “CZ particles”) and alumina particles. As described later, the honeycomb fired body is produced by extrusion-molding a raw material paste containing the CZ particles and the alumina particles into an extrudate, and firing the extrudate.

The presence of the above-described components in the honeycomb structured body of the present invention can be confirmed by X-ray diffraction (XRD).

The honeycomb structured body of the present invention may include a single honeycomb fired body or multiple honeycomb fired bodies. The multiple honeycomb fired bodies may be combined together with an adhesive layer therebetween.

In the honeycomb structured body of the present invention, a peripheral coat layer may be formed on the outer periphery of the honeycomb fired body.

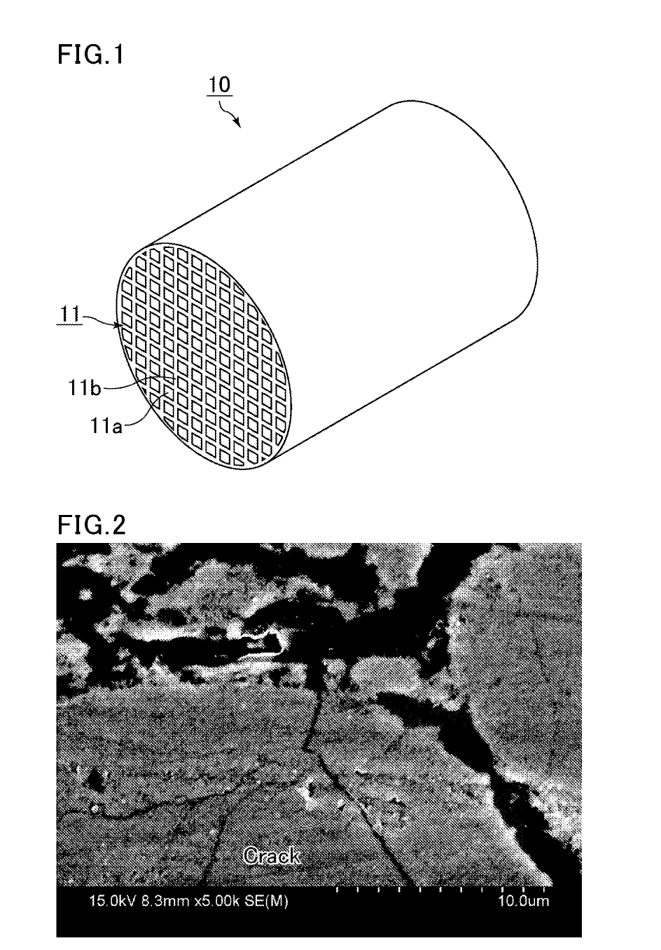

FIG. 1 is a perspective view schematically showing an exemplary honeycomb structured body of the present invention.

A honeycomb structured body 10 shown in FIG. 1 includes a single honeycomb fired body 11 in which multiple through-holes 11a are arranged longitudinally in parallel with one another with a partition wall 11b therebetween. The honeycomb fired body 11 contains CZ particles and alumina particles, and is in the form of an extrudate.

The CZ particles include cracked particles.

FIG. 2 is an electron microscope image of a honeycomb fired body containing a cracked particle. As is clear from this image, some particles are cracked. Multiple cracks may be present in one particle.

In the electron microscope image of the honeycomb fired body, if a crack is found in three or more out of ten ceria-zirconia composite oxide particles, it is determined that the ceria-zirconia composite oxide particles include cracked particles.

When the ceria-zirconia composite oxide particles including cracked particles are used as a raw material to produce a honeycomb fired body, the cracked particles used as the raw material remain in the resulting honeycomb fired body, with the cracks in the particles.

In the honeycomb structured body of the present invention, the CZ particles constituting the honeycomb fired body preferably have an average particle size of 1 to 50 μm in order to improve thermal shock resistance. In addition, the CZ particles preferably have an average particle size of 1 to 30 μm.

Cracks can be easily formed in the CZ particles having an average particle size of 1 to 50 μm.

In the honeycomb structured body of the present invention, the average particle size of the alumina particles constituting the honeycomb fired body is not particularly limited, but it is preferably 1 to 10 μm, more preferably 1 to 5 μm, in order to improve gas conversion performance and warm-up performance.

The average particle sizes of the CZ particles and the alumina particles constituting the honeycomb fired body can be determined by taking an SEM image of the honeycomb fired body with a scanning electron microscope (SEM “S-4800” available from Hitachi High-Technologies Corporation).

In the honeycomb structured body of the present invention, the CZ particle content is preferably 35 to 65% by weight.

In the honeycomb structured body of the present invention, the alumina particle content is preferably 15 to 35% by weight.

In the honeycomb structured body of the present invention, the ceria-zirconia composite oxide constituting the CZ particles is a material used as a co-catalyst (oxygen storage material) of an exhaust gas catalytic converter. The ceria-zirconia composite oxide is preferably a solid solution of ceria and zirconia.

In the honeycomb structured body of the present invention, the ceria-zirconia composite oxide may further contain another rare earth element different from cerium. Examples of the rare earth element include scandium (Sc), yttrium (Y), lanthanum (La), praseodymium (Pr), neodymium (Nd), samarium (Sm), gadolinium (Gd), terbium (Tb), dysprosium (Dy), ytterbium (Yb), and lutetium (Lu).

In the honeycomb structured body of the present invention, the ceria-zirconia composite oxide preferably contains ceria in an amount of 30% by weight or more and 90% by weight or less, more preferably 40% by weight or more and 80% by weight or less. The ceria-zirconia composite oxide preferably contains zirconia in an amount of 60% by weight or less, more preferably 50% by weight or less. Such a ceria-zirconia composite oxide has small thermal capacity, so that the honeycomb structured body can be easily heated, improving warm-up performance.

In the honeycomb structured body of the present invention, the type of the alumina particles is not particularly limited, but θ-phase alumina particles (hereinafter also referred to as “θ-alumina particles”) are preferred.

With the use of the θ-phase alumina particles as separators of the ceria-zirconia composite oxide particles, it is possible to increase the size of the pores in the partition walls, thus allowing gas to easily diffuse into the partition walls. In addition, with the use of the θ-phase alumina particles, it is possible to prevent phase change of the alumina in exhaust gas, thus further improving heat resistance.

In the honeycomb structured body of the present invention, the honeycomb fired body preferably contains inorganic particles used as an inorganic binder during production, and more preferably contains y-alumina particles derived from boehmite.

In the honeycomb structured body of the present invention, the honeycomb fired body preferably contains inorganic fibers, and more preferably contains α-alumina fibers.

The presence of the inorganic fibers such as α-alumina fibers can improve the mechanical characteristics of the honeycomb structured body.

The inorganic fibers refer to those having an aspect ratio of 5 or more. The inorganic particles refer to those having an aspect ratio of less than 5.

The honeycomb structured body of the present invention preferably has a length to diameter ratio (length/diameter) of 0.5 to 0.9, more preferably 0.6 to 0.8.

The honeycomb structured body of the present invention preferably has a diameter of 130 mm or less, more preferably 125 mm or less. The diameter of the honeycomb structured body is also preferably 85 mm or more.

In the honeycomb structured body of the present invention, the length of the honeycomb structured body is preferably 65 to 120 mm, more preferably 70 to 110 mm.

The shape of the honeycomb structured body of the present invention is not limited to a round pillar shape. Examples of the shape include a rectangular pillar shape, a cylindroid shape, a pillar shape with a racetrack end face, and a rectangular, pillar shape with rounded corners (e.g., a triangular pillar shape with rounded corners).

In the honeycomb structured body of the present invention, the partition wall of the honeycomb fired body preferably has a uniform thickness. Specifically, the partition wall of the honeycomb fired body preferably has a thickness of 0.05 to 0.50 mm, more preferably 0.10 to 0.30 mm.

In the honeycomb structured body of the present invention, the shape of the through-holes of the honeycomb fired body is not limited to a quadrangular pillar shape. For example, it may be a triangular pillar shape or a hexagonal pillar shape.

In the honeycomb structured body of the present invention, the density of the through-holes in a cross section perpendicular to the longitudinal direction of the honeycomb fired body is preferably 31 to 155 pcs/cm².

In the honeycomb structured body of the present invention, the honeycomb fired body preferably has a porosity of 40 to 70%. With the porosity of the honeycomb fired body in the above range, the honeycomb structured body can maintain its strength and exhibit high exhaust gas conversion performance at the same time.

The porosity of the honeycomb fired body can be measured by mercury porosimetry with a contact angle of 130° and a surface tension of 485 mN/m.

In the honeycomb structured body of the present invention, when a peripheral coat layer is formed on the outer periphery of the honeycomb fired body, the thickness of the peripheral coat layer is preferably 0.1 to 2.0 mm.

In the honeycomb structured body of the present invention, a noble metal is preferably supported on the honeycomb fired body.

Examples of the noble metal include platinum group metals such as platinum, palladium, and rhodium.

In the honeycomb structured body of the present invention, the amount of the noble metal supported is preferably 0.1 to 15 g/L, more preferably 0.5 to 10 g/L.

The term “amount of the noble metal supported” as used herein refers to the weight of the noble metal per apparent volume of the honeycomb structured body. The apparent volume of the honeycomb structured body includes the pore volumes. It includes the volume of the peripheral coat layer and/or the volume of an adhesive layer.

### (Method for Producing Honeycomb Structured Body)

Next, the method for producing a honeycomb structured body of the present invention is described.

The method for producing a honeycomb structured body of the present invention is a method for producing a honeycomb structured body including a honeycomb fired body in which multiple through-holes are arranged longitudinally in parallel with one another with a partition wall therebetween, the method including a heat-treating step of heat-treating ceria-zirconia composite oxide particles at 700° C. to 1000° C. for 1 to 24 hours while repeatedly switching between a reducing atmosphere and an oxidizing atmosphere to form cracks in at least some of the ceria-zirconia composite oxide particles; a molding step of molding a raw material paste containing the ceria-zirconia composite oxide particles including a cracked particle and alumina particles into a honeycomb molded body in which multiple through-holes are arranged longitudinally in parallel with one another with a partition wall therebetween; and a firing step of firing the honeycomb molded body into a honeycomb fired body.

### (Heat-Treating Step)

First, the heat-treating step is performed to form ceria-zirconia composite oxide particles including cracked particles.

The ceria-zirconia composite oxide particles can be prepared as follows. First, ceria-zirconia composite oxide can be prepared, for example, by adding ammonia water to an aqueous solution of cerium salt (such as cerium nitrate) and zirconium salt (such as zirconium oxynitrate) to induce co-precipitation, drying the resulting co-precipitate, and then firing the dried co-precipitate at 400° C. to 500° C. for about five hours.

Then, the prepared ceria-zirconia composite oxide is heat-treated at 700° C. to 1000° C. for 1 to 24 hours while repeatedly switching between a reducing atmosphere and an oxidizing atmosphere, whereby it is possible to form cracks in at least some of the ceria-zirconia composite oxide particles. The ceria-zirconia composite oxide particles having cracks formed therein are cracked particles.

The reducing atmosphere is an atmosphere in which oxygen can be released from the ceria-zirconia composite oxide particles. For example, it is an atmosphere with 0.3 to 0.7 vol % of carbon monoxide, 0 vol % of oxygen, and 99.3 to 99.7 vol % of nitrogen. More specifically, for example, it is an atmosphere with 0.5 vol % of carbon monoxide, 0 vol % of oxygen, and 99.5 vol % of nitrogen.

The oxidizing atmosphere is an atmosphere in which oxygen can be absorbed into the ceria-zirconia composite oxide particles. For example, it is an atmosphere with 1 to 10 vol % of oxygen and 90 to 99 vol % of nitrogen. More specifically, for example, it is an atmosphere with 5 vol % of oxygen and 95 vol % of nitrogen.

### (Molding Step)

In the molding step, first, a raw material paste is prepared which contains ceria-zirconia composite oxide particles including cracked particles and alumina particles.

Details (such as type and average particle size) of the ceria-zirconia composite oxide particles including cracked particles and the alumina particles have been described in the section “Honeycomb structured body”. Thus, detailed descriptions are omitted.

Examples of other raw materials for use in preparation of the raw material paste include inorganic fibers, inorganic binders, organic binders, pore-forming agents, forming auxiliaries, and dispersion media.

Any material may be used for the inorganic fibers. Examples include alumina, silica, silicon carbide, silica alumina, glass, potassium titanate, and aluminum borate. Two or more of these may be used in combination. Among these, alumina fibers are preferred, and α-alumina fibers are particularly preferred.

The inorganic fibers preferably have an aspect ratio of 5 to 300, more preferably 10 to 200, still more preferably 10 to 100.

Any inorganic binder may be used. Examples include solids contained in materials such as alumina sol, silica sol, titania sol, sodium silicate, sepiolite, attapulgite, and boehmite. Two or more of these inorganic binders may be used in combination.

Boehmite is preferred among these inorganic binders. Boehmite is alumina monohydrate with the composition AlOOH, and has good dispersibility in media such as water. Thus, boehmite is preferably used as the inorganic binder.

Any organic binder may be used. Examples include methyl cellulose, carboxymethyl cellulose, hydroxyethyl cellulose, polyethylene glycol, phenolic resin, and epoxy resin. Two or more of these may be used in combination.

Any pore-forming agent may be used. Examples include acrylic resin, coke, and starch. In the present invention, use of two or more of acrylic resin, coke, and starch is preferred.

The pore-forming agent is an agent that is used to create pores in a fired body when producing the fired body.

Any forming auxiliaries may be used. Examples include ethylene glycol, dextrins, fatty acids, fatty acid soaps, and polyalcohols. Two or more of these may be used in combination.

Any dispersion medium may be used. Examples include water and organic solvents such as benzene and alcohols such as methanol. Two or more of these may be used in combination.

When the CZ particles, alumina particles, α-alumina fibers, and boehmite are used as the raw materials of the raw material paste, the percentage of each of these materials relative to the total solids remaining in the raw material paste after the firing step is preferably as follows: CZ particles: 40 to 60% by weight, alumina particles: 15 to 35% by weight, α-alumina fibers: 5 to 15% by weight, and boehmite: 10 to 20% by weight.

Preparation of the raw material paste preferably involves mixing/kneading. A device such as a mixer or an attritor may be used for mixing, and a device such as a kneader may be used for kneading.

The raw material paste prepared by the above method is molded into a honeycomb molded body in which multiple through-holes are arranged longitudinally in parallel with one another with a partition wall therebetween.

Specifically, the raw material paste is extrusion-molded into a honeycomb molded body. In other words, the raw material paste is passed through a die of a specific shape to form a continuous honeycomb molded body having through-holes of a specific shape, and the continuous honeycomb molded body is cut to a specific length, whereby a honeycomb molded body is obtained.

Next, preferably, a dryer such as a microwave dryer, a hot-air dryer, a dielectric dryer, a reduced-pressure dryer, a vacuum dryer, or a freeze-dryer is used to dry the honeycomb molded body into a honeycomb dried body.

Herein, the honeycomb molded body before the firing step and the honeycomb dried body are also collectively referred to as a “honeycomb molded body”.

### (Firing Step)

In the method for producing a honeycomb structured body of the present invention, the honeycomb molded body is fired in the firing step into a honeycomb fired body. In this step, the honeycomb molded body is degreased and fired. Thus, the step can also be referred to as a “degreasing/firing step”, but is referred to as a “firing step” for the purpose of convenience.

The temperature in the firing step is preferably 800° C. to 1300° C., more preferably 900° C. to 1200° C. The duration of the firing step is preferably 1 to 24 hours, more preferably 3 to 18 hours. The atmosphere of the firing step is not particularly limited, but an atmosphere with an oxygen concentration of 1 to 20% by volume is preferred.

The honeycomb structured body can be produced by the above steps.

### (Supporting Step)

The method for producing a honeycomb structured body of the present invention preferably further includes a supporting step of allowing a noble metal to be supported on the honeycomb fired body.

Examples of the method for allowing a noble metal to be supported on the honeycomb fired body include a method in which the honeycomb fired body or the honeycomb structured body is immersed in a solution containing noble metal particles and/or a noble metal complex, and the honeycomb fired body or the honeycomb structured body is then removed and heated.

When the honeycomb structured body includes a peripheral coat layer, a noble metal may be supported on the honeycomb fired body before the peripheral coat layer is formed, or a noble metal may be supported on the honeycomb fired body or the honeycomb structured body after the peripheral coat layer is formed. In addition, when the honeycomb structured body includes an adhesive layer, a noble metal may be supported on the honeycomb fired body before the adhesive layer is formed, or a noble metal may be supported on the honeycomb fired body or the honeycomb structured body after the adhesive layer is formed.

In the method for producing a honeycomb structured body of the present invention, the amount of the noble metal to be supported in the supporting step is preferably 0.1 to 15 g/L, more preferably 0.5 to 10 g/L.

### (Other Steps)

In the case where the method for producing a honeycomb structured body of the present invention includes forming a peripheral coat layer on the outer periphery of the honeycomb fired body, the peripheral coat layer can be formed by applying a peripheral coat layer paste to the outer periphery of the honeycomb fired body excluding both end faces thereof, and then solidifying the peripheral coat layer paste by drying. A paste having the same composition as the raw material paste can be used as the peripheral coat layer paste.

In the method for producing a honeycomb structured body of the present invention, a honeycomb structured body including multiple honeycomb fired bodies bonded together via an adhesive layer can be produced by applying an adhesive layer paste to the outer periphery of each honeycomb fired body excluding both end faces thereof, bonding these honeycomb fired bodies together, and then solidifying the adhesive layer paste by drying. A paste having the same composition as the raw material paste can be used as the adhesive layer paste.

### EXAMPLES

Examples that more specifically disclose the present invention are described below. The present invention is not limited to these examples.

### (Production of Honeycomb Fired Body)

### Example 1

CZ particles (average particle size: 30 μm) were placed on a magnetic plate, and a heat-treating step was performed in which the CZ particles were heated at 800° C. for 10 hours under stirring while alternately switching gas conditions between an oxidizing atmosphere (carbon monoxide 0 vol %, oxygen 5 vol %, nitrogen 95 vol %) for one minute and a reducing atmosphere (carbon monoxide 0.5 vol %, oxygen 0 vol %, nitrogen 99.5 vol %) for one minute.

The following materials were mixed/kneaded to prepare a raw material paste: 26.4% by weight of the heat-treated CZ particles, 13.2% by weight of θ-alumina particles (average particle size: 2 μm), 5.3% by weight of α-alumina fibers (average fiber diameter: 3 μm, average fiber length: 60 μm), 11.3% by weight of boehmite as an inorganic binder, 5.3% by weight of methyl cellulose as an organic binder, 2.1% by weight of acrylic resin as a pore-forming agent, 2.6% by weight of coke also as a pore-forming agent, 4.2% by weight of polyoxyethylene oleyl ether (surfactant) as a forming auxiliary, and 29.6% by weight of ion-exchanged water.

Using an extruder, the raw material paste was extrusion-molded into a honeycomb molded body. Then, using a reduced-pressure microwave dryer, the honeycomb molded body was dried at an output of 1.74 kW under a reduced pressure of 6.7 kPa for 12 minutes, and then degreased/fired at 1100° C. for 10 hours, whereby a honeycomb fired body (honeycomb structured body) was produced. The honeycomb fired body has a round pillar shape with a diameter of 103 mm and a length of 80 mm in which the density of the through-holes was 77.5 pcs/cm² (500 cpsi) and the thickness of the partition wall was 0.127 mm (5 mil).

### Comparative Example 1

A honeycomb fired body was produced as in Example 1, except that the CZ particles (average particle size: 30 μm) were used without being heat-treated.

### (Evaluation of Honeycomb Fired Body)

### (1) Observation of CZ Particles

Electron microscope images of the honeycomb fired bodies of Example 1 and Comparative Example 1 which were produced by the above steps were observed to determine whether or not cracks were formed in the CZ particles. As a result, the CZ particles of the honeycomb fired body of Example 1 included cracked particles, but the CZ particles of the honeycomb fired body of Comparative Example 1 did not include cracked particles.

FIG. 2 is an electron microscope image of the honeycomb fired body containing a cracked particle, which was produced in Example 1.

### (2) Thermal Shock Resistance

Each of the honeycomb fired bodies of Example 1 and Comparative Example 1 which were produced by the above steps was enclosed in a metal container via an alumina mat, and the metal container was alternately aerated with air heated by a gas burner and room-temperature air. A heat cycle test was performed in which a heating and cooling cycle was repeated 100 times such that the temperature at the center of the honeycomb fired body was alternately switched between 200° C. and 950° C.

As a result, the honeycomb fired body of Example 1 showed no damage (no cracking) after the heat cycle test, but the honeycomb fired body of Comparative Example 1 showed damage (cracking) after the heat cycle test.

### REFERENCE SIGNS LIST

10 honeycomb structured body
11 honeycomb fired body
11a through-hole
11b partition wall

1. A honeycomb structured body comprising:
a honeycomb fired body in which multiple through-holes are arranged longitudinally in parallel with one another with a partition wall therebetween,
wherein the honeycomb fired body is an extrudate containing ceria-zirconia composite oxide particles and alumina particles,
the ceria-zirconia composite oxide particles have an average particle size of 1 to 50 μm, and
the ceria-zirconia composite oxide particles include a cracked particle.

2. The honeycomb structured body according to claim 1,
wherein the alumina particles are θ-phase alumina particles.

3. The honeycomb structured body according to claim 1,
wherein the honeycomb structured body has a length to diameter ratio (length/diameter) of 0.5 to 0.9.

4. The honeycomb structured body according to claim 1,
wherein the honeycomb structured body has a diameter of 130 mm or less.

5. The honeycomb structured body according to claim 1,
wherein a noble metal is supported on the honeycomb fired body.

6. A method for producing a honeycomb structured body comprising a honeycomb fired body in which multiple through-holes are arranged longitudinally in parallel with one another with a partition wall therebetween, the method comprising:
a heat-treating step of heat-treating ceria-zirconia composite oxide particles at 700° C. to 1000° C. for 1 to 24 hours while repeatedly switching between a reducing atmosphere and an oxidizing atmosphere to form cracks in at least some of the ceria-zirconia composite oxide particles;
a molding step of molding a raw material paste containing the ceria-zirconia composite oxide particles including a cracked particle and alumina particles into a honeycomb molded body in which multiple through-holes are arranged longitudinally in parallel with one another with a partition wall therebetween; and
a firing step of firing the honeycomb molded body into a honeycomb fired body.

7. The method for producing a honeycomb structured body according to claim 6,
further comprising a supporting step of allowing a noble metal to be supported on the honeycomb fired body.

8. The honeycomb structured body according to claim 2,
wherein the honeycomb structured body has a length to diameter ratio (length/diameter) of 0.5 to 0.9.

9. The honeycomb structured body according to claim 2,
wherein the honeycomb structured body has a diameter of 130 mm or less.

10. The honeycomb structured body according to claim 3,
wherein the honeycomb structured body has a diameter of 130 mm or less.

11. The honeycomb structured body according to claim 8,
wherein the honeycomb structured body has a diameter of 130 mm or less.

12. The honeycomb structured body according to claim 2,
wherein a noble metal is supported on the honeycomb fired body.

13. The honeycomb structured body according to claim 3,
wherein a noble metal is supported on the honeycomb fired body.

14. The honeycomb structured body according to claim 4,
wherein a noble metal is supported on the honeycomb fired body.

15. The honeycomb structured body according to claim 8,
wherein a noble metal is supported on the honeycomb fired body.

16. The honeycomb structured body according to claim 9,
wherein a noble metal is supported on the honeycomb fired body.

17. The honeycomb structured body according to claim 10,
wherein a noble metal is supported on the honeycomb fired body.

18. The honeycomb structured body according to claim 11,
wherein a noble metal is supported on the honeycomb fired body.
